(19) United States
(12) Patent Application Publication
(10) Pub. No.: US 2024/0152925 A1
(43) Pub. Date: May 9, 2024

(54) METHODS AND ARRANGEMENTS FOR CREDIT CARD LOCK

(71) Applicant: Capital One Services, LLC, McLean, VA (US)

(72) Inventors: Joshua Edwards, Philadelphia, PA (US); Julian Duque, Arlington, VA (US); Michael Mossoba, Arlington, VA (US)

(73) Assignee: Capital One Services, LLC, McLean, VA (US)

(21) Appl. No.: 17/983,802

(22) Filed: Nov. 9, 2022

(51) Int. Cl. G06Q 20/40; G06Q 20/20; G06Q 20/38

(52) U.S. Cl. CPC G06Q 20/4016; G06Q 20/20; G06Q 20/3829; G06Q 2220/00

(57) ABSTRACT

Logic may provide a lock for a credit card that may, e.g., prevent or attenuate fraudulent transactions. Logic may include one or more user interaction mechanisms to physically interact with a user to change a user-configurable circuit to create an unlock pattern with the user-configurable circuit to allow the payment instrument to authorize transactions and one or more lock patterns to prevent the payment instrument from authorizing transactions. The one or more user interaction mechanisms may comprise moveable conductors to connect or disconnect circuits of the user-configurable circuit to create the unlock pattern and the lock patterns. The logic may comprise a processor to process transactions and be coupled with memory. The logic may receive power from a point of sale (POS) terminal to process a transaction, apply the power to the user-configurable circuit, and determine an output of the user-configurable circuit to determine if the transaction succeeds or fails.

### TECHNICAL FIELD

Embodiments described herein are in the field of credit card fraud prevention. More particularly, the embodiments relate to methods and arrangements for integrating lock logic circuitry with a credit card for fraud prevention.

### BACKGROUND

A modern credit card has three primary methods of making an in-person transaction with a merchant: tap, chip, and swipe. Each method relies on different technology embedded within the credit card. These technologies are substantially independent of one another such that one payment method may fail while the other two continue to function. For instance, an induction loop within the credit card may break, causing the tap functionality to stop working, but the chip and swipe functionality may be unaffected.

When the credit card is lost, stolen, or skimmed, however, the various technologies may not prevent fraudulent transactions with the credit card. For instance, the tap, chip, or swipe may be accepted with a signature or pin that can be faked, observed, or skimmed; with easily determined information such as a zip code; or with other information entered by the user on a terminal that can be monitored, seen, or skimmed.

### SUMMARY

Embodiments may include methods and arrangements such as methods, devices, apparatuses, systems, storage media, and the like. For example, a first embodiment may include a payment instrument. The payment instrument may comprise one or more user interaction mechanisms, the one or more user interaction mechanisms to physically interact with a user to change a user-configurable circuit, wherein the user interaction mechanism creates an unlock pattern with the user-configurable circuit to allow the payment instrument to authorize transactions and one or more lock patterns to prevent the payment instrument from authorizing transactions. The payment instrument may also comprise memory; and logic circuitry comprising a processor to process transactions, the logic circuitry coupled with the memory to receive power from a point of sale (POS) terminal to process a transaction. The logic circuitry may apply the power to the user-configurable circuit, the user-configurable circuit coupled with one or more user interaction mechanisms. And the logic circuitry may determine an output of the user-configurable circuit to determine if the transaction succeeds or fails.

A second embodiment may include a non-transitory storage medium instructions, which when executed by a processor of a payment instrument, cause the processor to perform operations. The operations may, in response to initiation of a point of sale (POS) transaction, apply power to a user-configurable circuit, the user-configurable circuit to output an unlock code in response to selection of an unlock pattern of circuit connections in the user-configurable circuit The operations may receive a code at an input of the processor of the payment instrument in response to power applied to a user-configurable circuit, the code to comprise the lock code or the unlock code. And the operations may process the POS transaction via the code, wherein processing the POS transaction with the lock code generates a first communication that causes the POS transaction to fail and wherein processing the POS transaction with the unlock code generates a second communication that does not cause the POS transaction to fail.

A third embodiment may include a payment instrument. The payment instrument may comprise a user configurable circuit and a user interaction mechanism to physically interact with a user to configure the user-configurable circuit. The user interaction mechanism may comprise two or more slidable circuit connectors coupled with the user-configurable circuit, each slidable connector comprising a conductive element, the conductive element to electrically connect with the user-configurable circuit at one or more predefined locations. The payment instrument may also comprise memory; and a processor coupled with the memory and coupled with the user configurable circuit. The processor may identify a code from the user configurable circuit; and attempt to communicate with a point of sale (POS) terminal to process a transaction.

### BRIEF DESCRIPTION OF THE DRAWINGS

FIG. 1A depict embodiments of systems including servers, networks, and point-of-sale terminals to lock payment interfaces of payment instruments;

FIG. 1B depicts an embodiment of an apparatus such as a server or other computer to lock payment interfaces of payment instruments;

FIG. 2A depicts an embodiment of a payment instrument with multiple payment interfaces to process transactions with point-of-sale terminals such as the point-of-sale terminals in FIG. 1A;

FIG. 2B depicts an embodiment of a user interface mechanism and a user-configurable circuit for a payment instrument such as the payment instrument in FIG. 2A;

FIG. 2C-E depicts alternative details embodiments for a user-configurable circuit to couple with a user interface mechanism of a payment instrument such as the user interface mechanism in FIGS. 2A-B;

FIGS. 3A-D depict flowcharts of embodiments for processing a payment instrument with a lock by the payment instrument, a POS terminal, and payment service provider, such as the payment instruments, a POS terminals, and payment service providers shown in FIGS. 1A-B and 2A-E;

FIG. 4 depicts an embodiment of a system including a multiple-processor platform, a chipset, buses, and accessories such as the servers shown in FIGS. 1A and 1B; and

FIGS. 5-6 depict embodiments of a storage medium and a computing platform such as the server and the point-of-sale devices shown in FIGS. 1A-B.

### DETAILED DESCRIPTION OF EMBODIMENTS

The following is a detailed description of embodiments depicted in the drawings. The detailed description covers all modifications, equivalents, and alternatives falling within the appended claims.

Customers may begin to rely on one or more payment instruments such as credit cards to perform transactions. Many customers have typical, repetitive, or periodic expenses for which they rely on one or more credit cards. For instance, customers may use one or more credit cards to purchase gas for their vehicles once a week, eat lunch at a restaurant or cafeteria a few times a week, pick up groceries a few times a month, and/or the like. Some customers fall into a routine in which they use the same payment instrument to perform most of the day-to-day transactions because they prefer use of that card for one reason or another.

Many payment instruments are plastic and/or metal credit cards that include payment interfaces of various technologies to conduct transactions for customers. The payment interfaces may include a magnetic stripe including information associated with the customer that a card reader can read to process a transaction. Magnetic stripes contain magnetically-stored information for conducting a transaction and are typically applied to credit cards as a hot foil tape. In many embodiments, the credit cards include a high-coercivity magnetic stripe that requires a higher magnetic energy to record (e.g., 4000 oersted (Oe)) than medium-coercivity (e.g., 2750 Oe) and low-coercivity (e.g., 300 Oe).

Payment instruments may also comprise a chip such as a microchip with contacts as a payment interface and such payment instruments are often referred to as Chip and PIN (personal identification number) or Chip and Signature cards. The chip may comprise a processor that has a contacted payment interface. With the Chip and PIN cards, the POS terminal, if it has the corresponding capabilities, may verify the identity of the customer with a PIN via the chip, whereas Chip and Signature cards require a signature to verify the identity of the customer. In some embodiments, the chip may also generate a packet for transmission to the payment instrument issuer such as an encrypted packet with a random number that can verify the operation of the chip and the association of the chip with the customer's account.

Payment instruments may also comprise a contactless payment interface such as a near field communications (NFC) payment interface. In some embodiments, the contactless payment interface may comprise a legacy magnetetic stripe radio frequency identifier (RFID) tag and, in further embodiments, the contactless payment interface may comprise an NFC payment interface coupled with the chip. Either or both of such contactless payment interfaces may include an antenna that is typically embedded in the payment instrument and encircles a portion of the payment instrument. The antenna enables reception of radio signals and for interacting with a tap type payment interface on a POS terminal. Reception of the radio signals may include radio signals for communications between the processor on the payment instrument and the POS terminal and/or may include radio signals configured to transfer power from the POS terminal to the payment instrument wirelessly.

When the payment instrument is stolen, the encryption on the card does not prevent the thief from being able to use the card. Embodiments may offer a solution without additional knowledge. Embodiments may include a payment instrument that comprises a user interaction mechanism to physically interact with a user to configure a user-configurable circuit in and/or on the payment instrument. In other words, embodiments include a physical interaction element referred to a user interaction mechanism that can lock or unlock the payment instrument. The user can lock the payment instrument by configuring the user-configurable circuit to include a lock pattern and the user can unlock the payment instrument by configuring the user-configurable circuit to include an unlock pattern.

The user may select a lock pattern or an unlock pattern based with interactive elements referred to as connectors. The connectors may be manipulated to connect one or more circuits and/or disconnect one or more circuits. In some embodiments, the connectors include slidable connectors that can slide from one position to another through interaction with a user.

The user interaction mechanism may include markings to facilitate identification of one or more lock patterns and an unlock pattern. The markings may include letters, numbers, symbols, pictures, words, phrases, etcetera, printed or imprinted next to, e.g., slidable connectors that can slide into positions associated with the markings to allow a user to enter a connector code. One or more connector codes may create an unlock pattern in the user-configurable circuit and one or more other connector codes may create a lock pattern in the user-configurable circuit.

After the user provides a connector code via the user interaction mechanism, the user-configurable circuit may include an unlock pattern that allows a processor of the payment instrument to access a hidden code to process a point of sale (POS) transaction. For example, the hidden code may comprise a series of two or more numbers, characters, symbols, pictures, words, phrases, a combination thereof, a hash thereof, and/or the like. In some embodiments, the hidden code may include numbers selected from the credit card number and/or card verification value (CVV)/card verification code (CVC)/card identification number (CID)/card security code (CSC). In some embodiments, the hidden code may be selected independently from the credit card number, and, in some embodiments, a user may select a hidden code either prior to the manufacture of the payment instrument or after manufacture of the payment instrument. And, in some embodiments, the hidden code may be changed after the manufacture of the payment instrument.

In some embodiments, the connector code can be identified at the time of manufacture. In some embodiments, the connector code can be identified after the time of manufacture. And, in some embodiments, the connector code can be provided by the user. For instance, the user may provide optional markings for a face of the user interaction mechanism to identify a connector code. Entry of the connector code via, e.g., slidable connectors on the face of the payment instrument may configure an unlock pattern in a user-configurable circuit of the payment instrument and the user-configurable circuit may be integrated with circuitry of the payment instrument to perform an action that allows the processor of the payment instrument to access the hidden code.

In some embodiments that allow the user to select the connector code after receipt of the payment instrument, the payment service provider may include a set of one or more hidden codes associated with lock patterns (also referred to as lock codes) and a set of one or more hidden codes associated with unlock patterns (also referred to as unlock codes) for the user's payment instrument. The lock codes and unlock codes may each be associated with one or more of the connector codes, so the user's selection of a connector code allows the service provider to determine the hidden code associated with the connector code.

In other embodiments, the hidden code that is an unlock code is fixed at the time of manufacture of a blank payment instrument and the connector code may be determined at the time of printing the payment instrument for a particular user. In such embodiments, the user may select a connector code, which identifies how markings are made near the user-interaction mechanism.

Prior to using the payment instrument, the user may set the connector code with the user interactive mechanism to allow a hidden code to be provided to the processor. In some embodiments, if the connector code is the correct connector code to create the unlock pattern in the user-configurable circuit, the correct hidden code is accessible to the processor.

In some embodiments, if an incorrect connector code is set with the user interactive mechanism, an incorrect hidden code is accessible to the processor when the processor accesses the hidden code, and the payment instrument will fail to process the POS transaction correctly. For instance, the user-configurable circuit may block power or a current to a portion of the circuitry of the payment instrument such as power or a current to the processor, to the communications interface, to an antenna, to a memory element, and/or the like.

In some embodiments, if an incorrect connector code is set with the user interactive mechanism, the lock pattern of user-configurable circuit may prevent the payment instrument from communicating with the point-of-sale (POS) terminal. In some embodiments, if an incorrect connector code is set with the user interactive mechanism, the processor may receive or determine an incorrect decryption code to decrypt a security key such as a private key. In some embodiments, if an incorrect connector code is set with the user interactive mechanism, the processor may receive or determine an incorrect encryption code to encrypt a communication with the POS terminal and/or the payment service provider. In some embodiments, if an incorrect connector code is set with the user interactive mechanism, the processor may receive or determine an incorrect personal identification number to send to the payment service provider to authenticate the payment instrument. In some embodiments, if an incorrect connector code is set with the user interactive mechanism, the processor may receive or determine an incorrect decryption code to decrypt a security key such as a private key.

After receipt of the hidden code, the processor may process the hidden code to determine a decryption code or decryption key and/or an encryption code or key. After determining an encryption code or key for securing at least portions of a communication for a POS terminal and/or payment service provider, the processor may send the communication to the POS terminal via a communication interface

In several embodiments, if the payment instrument fails an attempt to process a transaction, the processor may increment a counter stored in a non-volatile memory element such as a flash memory element. In such embodiments, the processor may compare the count in the counter to a threshold for failed POS transaction attempts to determine if the count reaches or exceeds the threshold. If the count reaches or exceeds the threshold, the processor may not process subsequent POS transactions until the counter is reset. In some embodiments, the counter may be reset by the processor in response to a successful attempt to process a POS transaction.

In some embodiments, if the payment instrument fails an attempt to process a transaction, the payment service provider may increment a counter stored in a memory element associated with the payment instrument. In such embodiments, the payment service provider may compare the count in the counter to a threshold for failed POS transaction attempts to determine if the count reaches or exceeds the threshold. If the count reaches or exceeds the threshold, the payment service provider may not process subsequent POS transactions with the payment instrument until the counter is reset.

Note that logic circuitry refers to circuitry that implements logic with discrete components and/or integrated circuits; circuitry with processing capabilities to perform logic at least partially in the form of code along with the code; circuitry with buffers, other storage media, and/or other storage capabilities to store code along with the code; and/or a combination thereof.

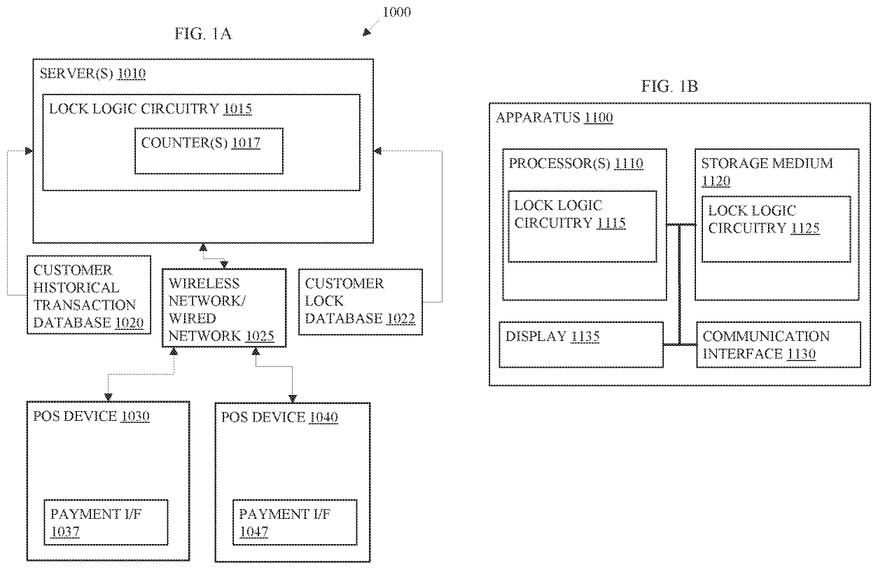

Turning now to the drawings, FIGS. 1A-B depict embodiments of systems including servers, networks, point-of-sale (POS) terminals, for payment instruments with lock logic circuitry. FIG. 1A illustrates an embodiment of a system 1000. The system 1000 may represent a portion of at least one wireless or wired network 1025 that interconnects server(s) 1010 with POS devices 1030 and 1040. The at least one wireless or wired network 1025 may represent any type of network or communications medium that can interconnect the server(s) 1010 and the POS devices 1030 and 1040, such as a cellular service, a cellular data service, satellite service, other wireless communication networks, fiber optic services, other land-based services, and/or the like, along with supporting equipment such as hubs, routers, switches, amplifiers, and/or the like.

In the present embodiment, the server(s) 1010 may represent one or more servers owned and/or operated by a company that provides services. In some embodiments, the server(s) 1010 represent more than one company that provides services. For example, a first set of one or more server(s) 1010 may provide services that process transactions for users (also referred to as customers). The first set of server(s) 1010 may comprise anonymized transaction data that, in many embodiments, comprise behavioral patterns, or transaction patterns, of multiple users to detect unusual spending patterns. In some embodiments, the transaction data is not anonymized. The first set of server(s) 1010 may access the transaction data from a customer historical transaction database 1020.

The second set of server(s) 1010 may perform additional fraud detection measures. In some embodiments, the second set of server(s) 1010 may include information unique to users' payment instruments to verify the authenticity of the payment instrument and/or the user of the payment instrument as well as maintain a count in a user-specific and/or payment instrument-specific counter(s) 1017. For example, the first set of server(s) 1010 may comprise lock logic circuitry 1015 to detect a problem in a communication with a POS terminal interacting with a payment instrument having a lock such as an incorrect PIN or a packet that cannot be decrypted with a security key associated with the payment instrument. For each failed attempt to process a transaction, the lock logic circuitry 1015 may increment or decrement maintain a count in a user-specific and/or payment instrument-specific counter(s) 1017.

The user-specific and/or payment instrument-specific counter(s) 1017 may include one or more counters that each store a count related to a user or a payment instrument. For instance, a user may have more than one payment instrument with a lock and, when the user-configurable circuit of a payment instrument has a lock pattern, the communications between the payment instrument and the payment service provider may have predictable issues such as an incorrect PIN or a packet that cannot be decrypted with a security key associated with the payment instrument. In some embodiments, the incorrect PIN may include an expected PIN if the user-configurable circuit includes a lock pattern while attempting to process a POS transaction. In other words, the lock logic circuitry 1015 may compare the incorrect PIN with PINs associated with the user in the customer lock database 1022. If incorrect PIN matches an incorrect PIN for the payment instrument in the customer lock database 1022, the second set of server(s) 1010 may fail the transaction and increment a user-specific counter and a payment instrument-specific counter of the counter(s) 1017. Some embodiments may implement the user-specific counter to detect potentially fraudulent transaction attempts with more than one payment instruments associated with a user.

In some embodiments, prior to processing a transaction by the first set of server(s) 1015, the lock logic circuitry 1015 in the second set of server(s) may compare the count in the user-specific counter against a user threshold and a count in the payment instrument-specific counter against a payment instrument threshold. If either or both counts reach or exceed the thresholds, the lock logic circuitry 1015 may fail the transaction attempt.

In some embodiments, the lock logic circuitry 1015 in the second set of server(s) 1010 may also include logic to reset the count in the user-specific and/or payment instrument-specific counter(s). For example, the lock logic circuitry 1015 may reset the counts in the user-specific and/or payment instrument-specific counter(s) in response to a successful attempt to process a POS transaction with the payment instrument of the user. For instance, for a user with two payment instruments with locks, the user may be associated with a user-specific counter and a counter for each of the payment instruments. If one payment instrument successfully processes a POS transaction, the user-specific counter and a counter for that payment instrument may be reset while the count for the payment instrument that was not used would not be reset. In other embodiments, the lock logic circuitry 1015 may maintain a single count for each payment instrument associated with a user and not a separate user-specific counter. In still other embodiments, the lock logic circuitry 1015 may maintain a single count for each user and not a separate payment instrument-specific counter.

To illustrate, POS devices 1030 and 1040 may represent terminals that two different retailers use to process transactions with payment instruments such as credit cards. POS device 1030 may represent a POS terminal at a gas pump of a gas station and the payment interface 1037 may be a payment interface of the POS terminal 1030. The payment interface 1037 may represent one or more payment interfaces such as a tap interface, a chip interface, and/or a magnetic stripe interface for processing transactions. To perform a transaction with the tap interface or a chip interface, the payment instrument is physically presented to the payment interface 1037 and, thus, the transaction is considered a “Card Present” transaction. Similarly, the POS device 1040 may comprise a payment interface 1047 to perform “Card Present” transactions for a grocery store and may require a payment instrument to be physically present to perform a transaction.

The user may set a connector code on the payment instrument via a user interactive mechanism on the payment instrument and may insert the payment instrument into a slot at the gas pump. The payment interface 1037 of the POS device 1030 may apply power to terminals on the payment instrument, providing power to a user-configurable circuit in the payment instrument. The user-configurable circuit may have an unlock pattern that unlocks the payment instrument for processing payments via the processor in the payment instrument and the POS device 1030.

In response to application of power and an initiation of a POS transaction via the POS device 1030, the user-configurable circuit may include a memory element accessible to the processor of the payment instrument including a hidden code. The processor may integrate the hidden code with part of an encryption code to create a complete encryption code and may encrypt a packet to include in a communication for a payment service provider represented herein by the server(s) 1010. After processing the POS transaction, the server(s) 1010 may transmit a communication indicating a successful processing of the transaction.

The user may change the connector code via the user interaction mechanism after successfully processing the gas transaction and misplace (or lose) the payment instrument. Thereafter, the payment instrument may be used at another retail store at the POS device 1040 with an incorrect connector code set on the user interaction mechanism. With an incorrect connector code, the payment instrument may integrate an incorrect hidden code in an encryption code used to encrypt a packet.

The lock logic circuitry 1015 of the payment service provider may first check the counter(s) to determine whether one or more of the counter(s) 1017 are equal to or exceed a threshold count for the processing the transaction. In the present embodiment, one or more of the counter(s) 1017 may have been reset after the successful attempt to process a transaction at the POS device 1030.

The lock logic circuitry 1015 of the payment service provider may determine that the encryption code used to encrypt the packet is incorrect. In some embodiments, lock logic circuitry 1015 may identify a decryption code from the customer lock database 1022 that decrypts the packet to confirms that the packet is encrypted with a known incorrect (or bad) encryption code. In response, the lock logic circuitry 1015 may fail the attempt to process the transaction and increment one or more counter(s) 1017.

FIG. 1B depicts an embodiment for an apparatus 1100 such as one of the server(s) 1010 shown in FIG. 1A. The apparatus 1100 may be a computer in the form of a smart phone, a tablet, a notebook, a desktop computer, a workstation, or a server. The apparatus 1100 can combine with any suitable embodiment of the systems, devices, and methods disclosed herein. The apparatus 1100 can include processor(s) 1110, a non-transitory storage medium 1120, communication interface 1130, and a display 1135. The processor(s) 1110 may comprise one or more processors, such as a programmable processor (e.g., a central processing unit (CPU)). The processor(s) 1110 may comprise processing circuitry to implement lock logic circuitry 1115 such as the lock logic circuitry 1015 shown in FIG. 1A.

The processor(s) 1110 may operatively couple with a non-transitory storage medium 1120. The non-transitory storage medium 1120 may store logic, code, and/or program instructions executable by the processor(s) 1110 for performing one or more instructions including the lock logic circuitry 1125. The non-transitory storage medium 1120 may comprise one or more memory units (e.g., removable media or external storage such as a secure digital (SD) card, random-access memory (RAM), a flash drive, a hard drive, and/or the like). The memory units of the non-transitory storage medium 1120 can store logic, code and/or program instructions executable by the processor(s) 1110 to perform any suitable embodiment of the methods described herein. For example, the processor(s) 1110 may execute instructions such as instructions of lock logic circuitry 1125 causing one or more processors of the processor(s) 1110 represented by the lock logic circuitry 1115 to compare one or more counts of failed POS transaction attempts against one or more thresholds to determine whether to fail a transaction attempt by a payment instrument. If the one or more counts do not exceed the one or more thresholds, the apparatus 1100 may continue to process the POS transaction for the payment instrument. The lock logic circuitry 1115 may attempt to decrypt an encrypted packet from the payment instrument for the transaction and, if the lock logic circuitry 1115 is not able to decrypt the packet with a correct decryption code, the lock logic circuitry 1115 may fail the attempted POS transaction and, in some embodiments, increment one or more counters associated with the payment instrument and/or a user associated with the payment instrument.

In response to a repeated attempt to process the POS transaction, the lock logic circuitry 1115 may check the counter(s) to determine if the count(s) in the counter(s) are less than the thresholds for failed attempts to process POS transactions. If the count(s) are less, then the lock logic circuitry 1115 may continue to process the transaction. The lock logic circuitry 1115 may decrypt the encrypted packet included in the transaction from the payment instrument with a correct decryption code. If the lock logic circuitry 1115 successfully decrypts the encrypted packet and verifies that the content of the encrypted packet authenticates the user of the payment instrument, the lock logic circuitry 1115 may verify the authentication of the user and the payment instrument. In some embodiments, the lock logic circuitry 1115 may also rest one or more of the counter(s) of failed attempts to process a POS transaction with the payment instrument.

The processor(s) 1110 may couple to a communication interface 1130 to transmit and/or receive data from one or more external devices (e.g., a terminal, display device, a smart phone, a tablet, a server, or other remote device). The communication interface 1130 includes circuitry to transmit and receive communications through a wired and/or wireless communication medium such as an Ethernet interface, a wireless fidelity (Wi-Fi) interface, a cellular data interface, and/or the like. In some embodiments, the communication interface 1130 may implement logic such as code in a baseband processor to interact with a physical layer device to transmit and receive wireless communications such as transaction data from a server or a data storage system. For example, the communication interface 1130 may implement one or more of local area networks (LAN), wide area networks (WAN), infrared, radio, Wi-Fi, point-to-point (P2P) networks, telecommunication networks, cloud communication, and the like.

The processor(s) 1110 may couple to a display 1135 to display a message or notification via, graphics, video, text, and/or the like. In some embodiments, the display 1135 may comprise a display on a terminal, a display device, a smart phone, a tablet, a server, or a remote device.

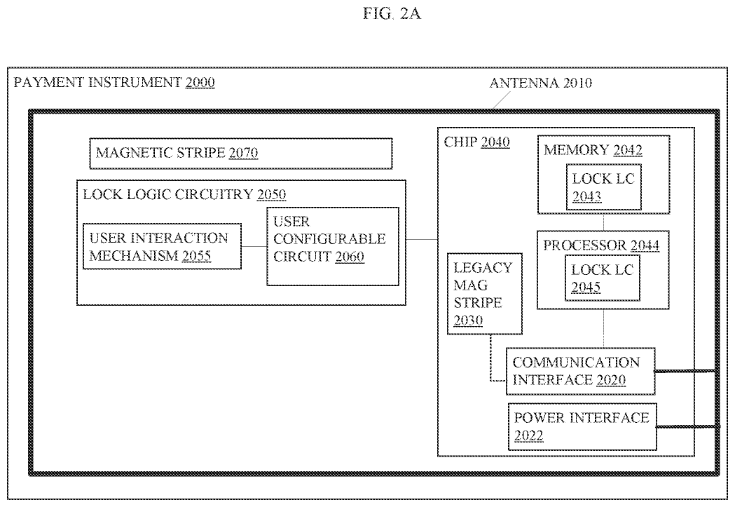

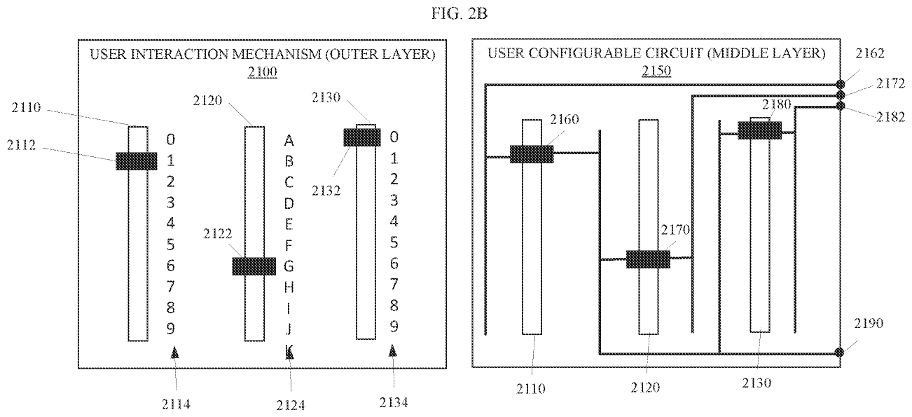

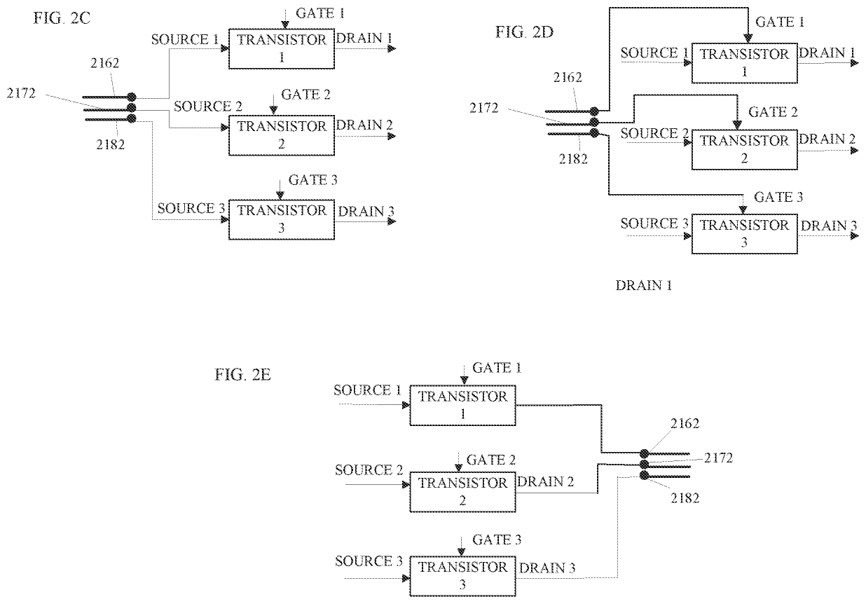

FIG. 2A depicts an embodiment for a payment instrument 2000 such as a credit card with multiple payment interfaces to conduct transactions with POS terminals such as the POS devices 1030 and 1040 shown in FIG. 1A. The payment instrument 2000 may be plastic, metal, or other material. In the present embodiment, the payment instrument 2000 comprises an antenna 2010 coupled with a chip 2040, a lock logic circuitry 2050 coupled with the chip 2040, and a magnetic stripe 2070. The magnetic stripe 2070 may include information about the payment instrument and user on a magnetic medium attached to an outside surface of the payment instrument. Some embodiments may not include a magnetic stripe 2070.

The antenna 2010 may comprise a conductive material that forms a loop around at least a portion of the payment instrument 2000. If the payment instrument 2000 comprises a conductive material an outer layer, a non-conductive material may isolate the loop of the antenna 2010 from conductive materials in the payment instrument 2000. The antenna 2010 may comprise one or more antennas that can be connected together to act as a single antenna or disconnected to operate as more than one distinct antennas. Each of the antennas that for the antenna 2010 may form a loop about the entire payment instrument and/or about a portion of the payment instrument. In many embodiments, the antennas comprise conductors to receive electromagnetic radiation or waves for wireless communications and/or for wireless power transfer from, e.g., a POS terminal. Some embodiments may comprise an antenna configuration for capturing power from electromagnetic waves that is different from the antenna configuration for wireless communications. In some embodiments, wireless communications may occur after the power interface 2022 captures enough energy from the electromagnetic waves to power wireless communications via the communications interface 2020.

The chip 2040 may comprise one or more layers of transistors coupled together with conductors on one or more middle layers of the payment instrument 2000. For instance, the payment instrument may comprise three or more layers of laminations including two outer layers forming the front and the back of the payment instrument as well as one or more middle layers. The chip 2040 may reside primarily in the middle layers and may have contacts on at least one outer layer of the payment instrument if the chip is configured for direct contact with a POS terminal.

The chip 2040 may comprise a microchip, other processor, and/or integrated circuit including memory. The chip 2040 may comprise memory 2042 to store temporary and/or persistent data and a processor 2044 coupled with the memory 2042 to process transactions. In some embodiments, the processor 2044 and/or the memory 2042 may include lock logic circuitry 2043 in the form of instructions stored in the memory 2042 and may include lock logic circuitry 2045 in the form of instructions in memory (such as buffers, registers, and/or the like) or processing pipelines integral to the processor 2044.

The lock logic circuitries 2043 and 2045 may include instructions to cause the processor to perform operations such as the lock logic circuitries 1015, 1115, and 1125 shown in FIGS. 1A-B. For instance, the processor 2044 may execute a counter to maintain a count of failed attempts to process transactions in the memory 2042 and/or in the processor 2044. The processor 2044 may compare the count to a threshold count in response to initiation of a POS transaction. If the count is less than the threshold, the processor 2044 may process the POS transaction. If the count is equal to or greater than the threshold, the processor 2044 may not attempt to process the POS transaction. In some embodiments, the count is reset by the processor 2044 in response to a successful attempt to process a POS transaction. A successful attempt may include communications with the POS terminal and/or a payment service provider. In some embodiments, the processor 2044 may maintain more than one count.

In many embodiments, a failed attempt is verified to have failed as a result of the lock logic circuitry 2050 to advantageously avoid counting failed attempts that are caused due to an error with the POS terminal. For example, the lock logic circuitry 2050 may cause a POS terminal transaction to fail by a process that can be identified by the lock logic circuitry 2043 and 2045 such as provision of a hidden code that causes the processor to fail the POS transaction. In one embodiment, the lock logic circuitry 2050 may produce an output of a hidden code to the processor 2044 to instruct the processor 2044 to fail the attempt to process a POS transaction. In other embodiments, the lock logic circuitry 2050 may output a hidden code that is not the correct hidden code that the processor 2044 requires to process a POS transaction correctly.

The chip 2040 may also comprise a legacy magnetic stripe 2030 coupled with the communication interface 2020 and a power interface 2022 coupled with the antenna 2010 or another antenna. The communication interface 2020 may include a contacted interface to directly connect with a POS terminal and/or a wireless or contactless interface such as a near-field communications interface. In some embodiments, the communications interface may also be referred to as the tap interface. The communication interface 2020 may be a passive device that draws power from a transmitter via the power interface 2022 to activate, receive a transmission, and transmit a response. In other embodiments, the communication interface 2020 may comprise a battery-powered, active interface or a battery-assisted, passive interface.

The legacy magnetic stripe 2030 may comprise a radio frequency identification (RFID) tag. The tag may comprise an integrated circuit coupled with the communication interface 2020 and the antenna 2010 to respond to a transmitter of a POS terminal, such as the POS device 1030 shown in FIG. 1A, with information such as the information stored on the magnetic stripe 2050. In some embodiments, the legacy magnetic stripe 2030 includes security protocols such as short transmission ranges, rolling codes, challenge-response authentication, and/or cryptographically coded responses.

The legacy magnetic stripe 2030 may couple with the wireless communication interface 2020 to conduct a transaction via a contactless interface, or tap interface, of the payment instrument 2000. In some embodiments, the legacy magnetic stripe 2030 may comprise the only device to conduct transactions through a tap interface of the payment instrument 2000. In other embodiments, the legacy magnetic stripe 2030 may comprise one of multiple devices that can conduct transactions through the tap interface of the payment instrument 2000.

Some embodiments of the payment instrument 2000 may have two payment interfaces such as a combination of the chip 2040 as a contacted interface and the magnetic stripe 2050 as a contacted interface. Other embodiments may comprise three payment interfaces such as a combination of the chip 2040 as a contacted interface, the magnetic stripe 2050 as a contacted interface, and the legacy magnetic stripe 2030 as a contactless interface. Further embodiments may have any number of payment interfaces such as the payment interfaces discussed herein or other payment interfaces.

The lock logic circuitry 2050 may comprise a user interaction mechanism 2055 and a user-configurable circuit 2060. The user interaction mechanism 2055 may be a physically interactive interface for a user to identify a connector code. In some embodiments, the user interaction mechanism 2055 may comprise moveable connectors such as slidable connectors that interact with the user-configurable circuit 2060 to form an unlock pattern or a lock pattern in the user-configurable circuit 2060. If the user interacts with the user interaction mechanism 2055 to set a correct connector code, the user-configurable circuit 2060 may include the unlock pattern. If the user interacts with the user interaction mechanism 2055 to set an incorrect connector code, the user-configurable circuit 2060 may include the lock pattern. Some embodiments may include one unlock pattern and one lock pattern. Some embodiments may include one unlock pattern and two or more lock patterns. Some embodiments may include more than one unlock pattern and more than one lock pattern. And some embodiments, may include more than one unlock pattern and more than one lock pattern. In some embodiments, the more than one unlock patterns may comprise equivalent circuits that produce the same output. In some embodiments, the more than one lock patterns may comprise equivalent circuits that produce the same output.

In some embodiments, the unlock pattern may provide or make accessible a hidden code to the processor 2044 and the processor may use the hidden code to decrypt an encryption key decrypt a portion of an encryption key, determine a decryption code, determine an encryption code, determine a PIN, decrypt a PIN, decrypt a portion of a PIN, and/or the like. In other embodiments, the user-configurable circuit 2060 may open a circuit or close a circuit to cause to cause the processing of a POS transaction to fail. For instance, the user-configurable circuit 2060 may open one or more circuits to prevent the payment instrument from communicating with the POS terminal such as a circuit to connect the antenna, a circuit to power a bit line or word line of a memory element containing a hidden code, a power supply line for the communication interface 2020, a power supply line for the legacy magnetic stripe 2030, a power supply line for the memory 2042, a power supply line for the processor 2044, a bit line of a bus coupling the processor 2044 with the memory 2042 or the communication interface 2020, a combination thereof, and/or the like.

FIG. 2B depicts an embodiment of a user interaction mechanism 2100 on an outer layer of a payment instrument and a user-configurable circuit 2150 on a middle layer of the payment instrument such as the payment instrument 2000 shown in FIG. 2A. The user interaction mechanism 2100 comprises slots 2110, 2120 and 2130. Each slot resides partially in the outer layer and partially in a middle layer of the user-configurable circuit 2150. The slots 2110, 2120, and 2130 include slidable connectors that have a user interactive component 2112, 2122, and 2132, respectively, on the outer layer and a conductor component 2160, 2170, and 2180, respectively, in the middle layer. Furthermore, the outer layer includes markings 2114, 2124, and 2134 to help the user select a position within the slots 2110, 2120 and 2130 for each of the slidable connectors.

In the present embodiment, the slidable connectors set a connector code of “1” in slot 2110, “G” in slot 2120, and “0” in slot 2130. Note that the markings may also or alternatively include words, phrases, pictures, and/or any other type of distinguishable markings that a user may use to distinguish the positions in the slots. In many embodiments, the moveable connectors snap into each of the positions via grooves in the outer layer and/or middle layer for the moveable connectors.

In the present embodiment, each of the conductors 2160, 2170, and 2180 couples with a common terminal 2190 and well as different output terminals 2162, 2172, and 2182. In some embodiments, the conductors 2160, 2170, and 2180 may not couple with a common terminal 2190 but may couple with independent terminals on each side of the conductor. Note that the user-configurable circuit 2150 has an unlock pattern because the correct connector code is set with the user interaction mechanism. If the slidable connector of slot 2114 was in the position “9” according to the markings 2114, the conductor 2160 would not be in contact with the terminals 2162 and 2190. In some embodiments, setting the incorrect connector code may couple the conductor 2160 with a different circuit terminal or set of terminals. In the present embodiment, setting the incorrect connector code disconnects the conductor 2160 from any electrical connection.

Note that this is one embodiment and that other embodiments may include more or less moveable connectors such as the slidable connectors 2110, 2120, and 2130, and more or less slots such as the slots 2110, 2120, and 2130. Other embodiments may have different markings 2114, 2124, and 2134 for the slots 2110, 2120, and 2130 and/or different combinations of markings 2114, 2124, and 2134. And other embodiments may include different configurations of moveable connectors to configure the user-configurable circuit 2150.

FIGS. 2C, 2D, and 2E depicts alternative embodiments of details of the user-configurable circuit 2150 to interface with other circuitry of the payment instrument 2000. In some embodiments, the transistors 1, 2, and 3 as shown may be part of the user-configurable circuit 2150. In other embodiments, the transistors 1, 2, and 3 as shown may be part of the circuitry of the payment instrument such as the payment instrument 2000 shown in FIG. 2A. Note also that the number of outputs from the moveable connectors differs in different embodiments. Furthermore, each transistor 1, 2, and 3, may represent a single transistor or more than one transistors connected in parallel.

FIG. 2C illustrates the embodiment where the terminals 2162, 2172, and 2182 couple with the source of transistors 1, 2, and 3 respectively, to, e.g., drive the current through the transistors 1, 2, and 3 when the gates of the transistors 1, 2, and 3 open the channels through the transistors.

FIG. 2D illustrates the embodiment where the terminals 2162, 2172, and 2182 couple with the gate of transistors 1, 2, and 3 respectively, to, e.g., open or close the channels of the respective transistors. FIG. 2E illustrates the embodiment where the terminals 2162, 2172, and 2182 couple with the drain of transistors 1, 2, and 3 respectively, to, e.g., receive a sourced current via the channels of the respective transistors when the gates of the transistors open the channels.

Other embodiments may configure the user-configurable circuit differently such as connecting the circuits to capacitors or other electrical components in the payment instrument circuitry.

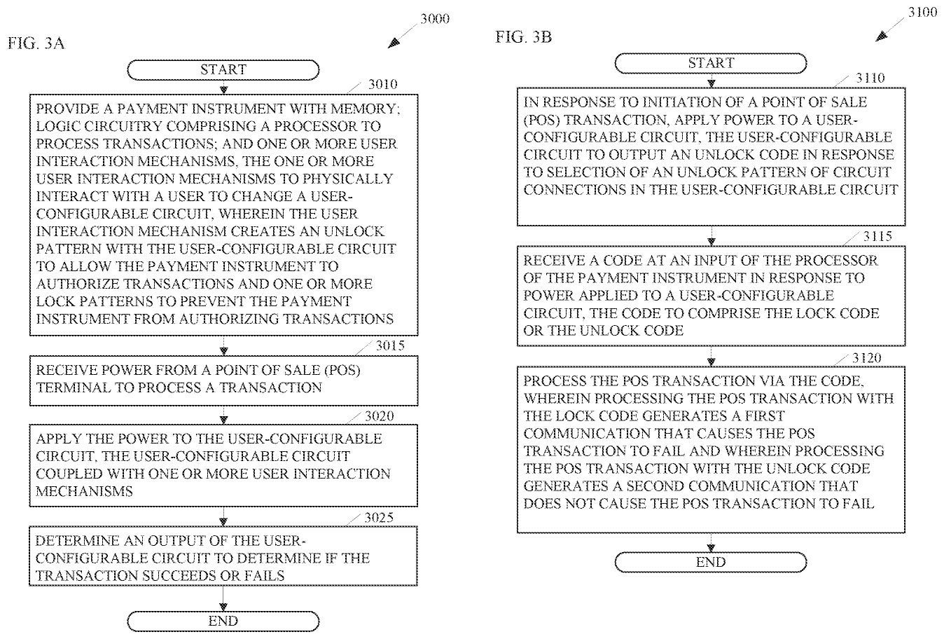

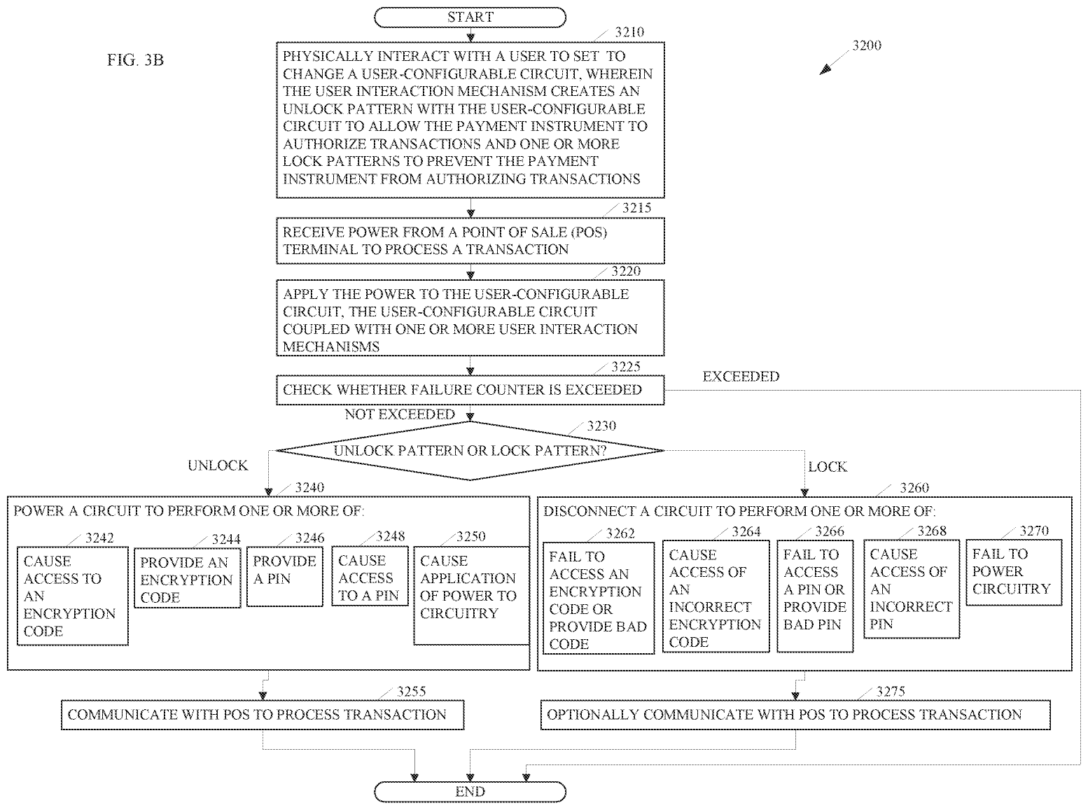

FIGS. 3A-D depict flowcharts 3000, 3100, 3200, and 3300 of embodiments for a payment instrument with a lock, by a payment instrument and/or lock logic circuitry, such as the payment instrument in FIGS. 2A-E and the lock logic circuitry shown in FIGS. 1A-B. FIG. 3A illustrates a flowchart 3000 for a payment instrument with a lock. The flowchart 3000 starts with provision of a payment instrument with memory; logic circuitry comprising a processor to process transactions; and one or more user interaction mechanisms (element 3010). The one or more user interaction mechanisms may physically interact with a user to change a user configurable circuit. For instance, the user interaction mechanism may create an unlock pattern with the user configurable circuit to allow the payment instrument to authorize transactions and may create one of one or more lock patterns to prevent the payment instrument from authorizing transactions.

In some embodiments, positioning of the one or more user interaction mechanisms to create the unlock pattern is user definable, is defined at a time of manufacture of the payment instrument, or a combination thereof. In some embodiments, the one or more user interaction mechanisms may comprise moveable conductors to connect or disconnect circuits of the user configurable circuit to create the unlock pattern or to create one of the lock patterns. In some embodiments, at least one of the one or more user interaction mechanisms connects a circuit of the user configurable circuit with a conductor. In further embodiments, at least one of the one or more user interaction mechanisms disconnects a circuit of the user configurable circuit with a conductor. In some embodiments, the state of the user interaction mechanism may both connect a circuit of the user configurable circuit with a conductor and disconnect a circuit of the user configurable circuit with a conductor.

In some embodiments, the unlock pattern provides power to the processor and the unlock pattern prevents power from being applied to the processor. In some embodiments, the unlock pattern provides a portion of an encryption code to an input of the processor to allow use of an encryption key. In some embodiments, the unlock pattern provides an authentication code to an input of the processor to authenticate a known environment of the processor.

After the user sets the state of the user interaction mechanism, the payment instrument may receive power from a point of sale (POS) terminal to process a transaction (element 3020). In several embodiments, POS terminal may transfer power to the payment instrument via wireless power transfer and/or via contacted power transfer through contacts accessible to the POS when contacts on the payment instrument physically connect with contacts of the POS terminal.

In some embodiments, the logic circuitry further comprises a counter to count a number of failed attempts to process a transaction and a comparator to determine if the number of failed attempts exceeds a threshold.

Once the payment instrument receives power from the POS terminal, the payment instrument may determine an output of the user configurable circuit to determine if the transaction succeeds or fails (element 3025). For instance, the payment instrument may determine that the POS transaction is a failed attempt when the POS terminal is unable to understand an encrypted message generated via an encryption code including a hidden code received via the user configurable circuit. In some embodiments, the payment instrument may determine that the POS transaction is a failed attempt when the payment service processor is unable to understand an encrypted message generated via an encryption code including a hidden code received via the user configurable circuit. In some embodiments, the payment instrument may determine that the POS transaction is a failed attempt when the payment service processor does not accept a PIN including a hidden code received via the user configurable circuit.

FIG. 3B illustrates a flowchart 3100 for a payment instrument with a lock. The flowchart begins with applying, in response to initiation of a point of sale (POS) transaction, power to a user-configurable circuit, the user-configurable circuit to output an unlock code in response to selection of an unlock pattern of circuit connections in the user-configurable circuit (element 3110). In other words, when the payment instrument is placed in contact with a POS terminal or near a wireless POS terminal, the payment instrument may receive power from the POS terminal during the initiation of the POS transaction. The circuitry of the payment instrument may connect the power directly to the user-configurable circuit and/or power distribution circuitry. In some embodiments, the user configurable circuit may determine the circuitry of the payment instrument that receives power based on the state of the user interaction mechanism and, in some embodiments, depending on the state of slidable connectors of the user interaction mechanism.

After the application of power to the user configurable circuit, a processor of the payment instrument may receive a code at an input of the processor of the payment instrument in response to power applied to a user-configurable circuit, the code to comprise the lock code or the unlock code (element 3115). The processor may process the POS transaction via the code, wherein processing the POS transaction with the lock code generates a first communication that causes the POS transaction to fail and wherein processing the POS transaction with the unlock code generates a second communication that does not cause the POS transaction to fail (element 3120).

The code may comprise a hidden code that is provided to the processor of the payment instrument if the state of the user interaction mechanism configures the correct user-configurable circuit. In some embodiments, if the state of the user interaction mechanism does not configure the user-configurable circuit correctly, the payment instrument will not be able to process the POS transaction correctly. For instance, with the processor may receive a portion of an encryption code or a decryption code that is incorrect and may integrate the portion of the encryption code or decryption code with another portion of the code available via memory of the payment instrument to generate the entire encryption code or decryption code. When the portion of the code integrated is incorrect, in some embodiments, the attempt to communicate with the POS terminal and/or the payment service processor may fail. In other embodiments, the communications with the POS terminal and/or the payment service processor may succeed but the payment service processor may detect an indication of the incorrect encryption code or decryption code in the communication, allowing the payment service processor to implement fraud mitigation measures.

FIG. 3C illustrates a flowchart 3200 for a payment instrument with a lock. The flowchart 3200 begins with physically interact with a user to set to change a user-configurable circuit, wherein the user interaction mechanism creates an unlock pattern with the user-configurable circuit to allow the payment instrument to authorize transactions and one or more lock patterns to prevent the payment instrument from authorizing transactions (element 3210). For instance, in some embodiments, setting slidable connectors on the user interaction mechanism to the correct connector code may create the unlock pattern in the user-configurable circuit and the unlock pattern may cause a correct hidden code to be provided to the processor by the unlock pattern or via the unlock pattern in response to the application of power to the unlock pattern.

In some embodiments, setting slidable connectors on the user interaction mechanism to an incorrect connector code may create the lock pattern in the user-configurable circuit and the lock pattern may cause an incorrect hidden code to be provided to the processor by the lock pattern or via the lock pattern in response to the application of power to the lock pattern.

After the user sets the connector code via the slidable connectors, the payment instrument may receive power via a POS terminal (element 3215) and may apply power to the user-configurable circuit coupled with the one or more user interaction mechanisms (element 3220). In such embodiments, circuitry of the payment instrument that physically connects to circuitry of the POS terminal may receive power via the physical connections and/or circuitry of the payment instrument that wirelessly connects to circuitry of the POS terminal may receive power wirelessly via one or more antennas of a wireless interface such as an NFC interface.

After receiving power from the POS terminal, the processor may execute code to check the status of a failed transaction attempt counter (or failure counter) to determine whether a count in the failed transaction attempt counter exceeds a threshold failure count (element 3225). If the count in the failure counter exceeds the threshold failure count, the payment instrument may terminate the POS transaction by, e.g., not responding to initiation of the transaction by the POS terminal. In some embodiments, the payment instrument may respond to the POS terminal with an indication for the payment service provider that the transaction might be fraudulent.

If the count in the failure counter has not exceeded the threshold failure count, the processor may receive a hidden code, the value of which depends on the state of the user-configurable circuit. If the connector code on the user interface mechanism is the correct connector code, the user-configurable circuit may form an unlock pattern and, if the connector code on the user interface mechanism is an incorrect connector code, the user-configurable circuit may form a lock pattern (element 3230).

If the state of the user-configurable circuit includes an unlock pattern, interaction with a POS terminal may provide power to the user-configurable circuit and the user-configurable circuit may perform one or more functions. The one or more functions may comprise, e.g., causing access to an encryption code (element 3242), providing an encryption code (element 3244), providing a PIN (element 3246), causing access to a PIN (element 3248), causing application of power to circuitry (element 3250), a combination thereof, and/or the like. To cause access to an encryption code (element 3242), the unlock pattern may physically connect a memory element to the user-configurable circuit that includes the encryption code so the processor can access the encryption code. In further embodiments, the unlock pattern may connect a pattern of two or more bits to an input of the processor and the pattern of two or more bits may be the encryption code. In still further embodiments, the unlock pattern may connect a decryption code to an input of the processor or provide access by the processor to a memory element that contains a decryption code. In such embodiments, the decryption code may be used by the processor or other portion of the circuitry of the payment instrument to decrypt an encryption code from memory coupled with the processor.

To provide an encryption code (element 3244), the unlock pattern may output a bit pattern representative of the connector code, output a bit pattern in response to the connector code, output a value from which the processor derives the encryption code retrieved, output a bit pattern to append to another portion of the encryption code retrieved by the processor from the memory, and/or the like. To provide a PIN (element 3246), the unlock pattern may output a bit pattern representative of the connector code as the PIN to the processor, output a bit pattern to append to another portion of the PIN retrieved by the processor from the memory, output a bit pattern from which the processor calculates the PIN, and/or the like

To cause access to a PIN (element 3248), the unlock pattern may physically connect a memory element to the user-configurable circuit that includes the PIN so the processor can access the PIN via the user-configurable circuit. In further embodiments, the unlock pattern may connect a pattern of two or more bits to an input of the processor and the pattern of two or more bits may be the PIN. In still further embodiments, the unlock pattern may connect a decryption code to an input of the processor or provide access by the processor to a memory element that contains a decryption code. In such embodiments, the decryption code may be used by the processor or other portion of the circuitry of the payment instrument to decrypt the PIN from memory coupled with the processor

To cause application of power to circuitry (element 3250), the unlock pattern may connect or disconnect portions of the user-configurable circuit to enable and/or disable portions of the circuitry on the payment instrument. For example, if the correct connector code is set with the user interaction mechanism, application of power to the user configurable circuit may turn on or off channels of one or more transistors to power one or more portions of the circuitry on the payment instrument such as portions of the memory, the processor, the wireless communication interface such as an NFC interface, and/or other circuitry. Connecting power to, e.g., bit lines and/or word lines in a portion of a circuit based on entry of a correct connector code may allow access to non-volatile memory containing data such as a PIN (or portion thereof), a decryption key (or portion thereof), an encryption key (or portion thereof), and/or the like.

After providing power to a circuit to perform actions to access the PIN, encryption key, decryption key, and/or the like, the processor of the payment instrument may communicate with the POS to process the transaction (element 3255). With the correct PIN, encryption key, decryption key, and/or the like, the payment instrument may communicate with the POS and communicate with the payment service provider to authenticate the payment instrument and process the transaction.

If the state of the user-configurable circuit includes a lock pattern, interaction with a POS terminal may disconnect a circuit or provide power to a circuit of the user-configurable circuit to perform one or more functions. The one or more functions may comprise, e.g., failing to access to an encryption code or providing a bad encryption code (element 3262), causing access to an incorrect encryption code (element 3264), failing to access a PIN or providing a bad PIN (element 3266), causing access to an incorrect PIN (element 3268), causing or failing to apply power to circuitry (element 3270), a combination thereof, and/or the like. To fail to access to an encryption code or providing a bad encryption code (element 3262), the lock pattern may open a circuit to cut power to a word line or bit line of a memory element, open a circuit of a bus (or at least one wire of a bus) such as a serial bus to a memory element, change a bit indication of the encryption code or a portion thereof, and/or the like.

To cause access to an incorrect encryption code (element 3264), the lock pattern may physically connect a memory element to the user-configurable circuit that includes the encryption code by, e.g., closing or opening a contact, so the processor can access the incorrect encryption code. In further embodiments, the lock pattern may connect a pattern of two or more bits to an input of the processor and the pattern of two or more bits may be the incorrect encryption code. In still further embodiments, the lock pattern may connect an incorrect decryption code to an input of the processor or provide access by the processor to a memory element that contains an incorrect decryption code. In such embodiments, the incorrect decryption code may be used by the processor or other portion of the circuitry of the payment instrument to decrypt an incorrect encryption code from memory coupled with the processor or to not be able to decrypt the correct encryption code from memory.

To fail to access a PIN or providing a bad PIN (element 3266), the unlock pattern may physically disconnect a memory element to the user-configurable circuit that includes the PIN so the processor cannot access the PIN via the user-configurable circuit. In some embodiments, the lock pattern may connect a pattern of two or more bits to an input of the processor and the pattern of two or more bits may be the bad PIN. In still further embodiments, the lock pattern may connect a bad decryption code to an input of the processor or provide access by the processor to a memory element that contains a bad decryption code. In such embodiments, the bad decryption code may be used by the processor or other portion of the circuitry of the payment instrument to decrypt the PIN from memory coupled with the processor, which provides an incorrect PIN. In some embodiments, the payment service processor may determine that the bad PIN is indicative of a potentially fraudulent transaction and take appropriate fraud prevention measures.

To cause access of an incorrect PIN (element 3268), the lock pattern may physically connect a memory element to the user-configurable circuit that includes an incorrect PIN and/or provide a memory address for a bad PIN. In some embodiments, the manufacture of the payment instrument may establish a bad PIN at the time of manufacture of the payment instrument. In such embodiments, the bad PIN may be established randomly, by the user, or otherwise selected from a set of bad PINs.

To cause a failure to apply power to selected or all circuitry of the payment instrument (element 3270), the lock pattern may connect or disconnect portions of the user-configurable circuit to enable and/or disable portions of the circuitry on the payment instrument. For example, if the incorrect connector code is set with the user interaction mechanism, application of power to the user configurable circuit may turn on or off channels of one or more transistors to power one or more portions of the circuitry on the payment instrument such as portions of the memory, the processor, the wireless communication interface such as an NFC interface, and/or other circuitry. Disconnecting power to, e.g., bit lines and/or word lines in a portion of a circuit based on entry of an incorrect connector code may prevent access to non-volatile memory containing data such as a PIN (or portion thereof), a decryption key (or portion thereof), an encryption key (or portion thereof), and/or the like.

In some embodiments, after connecting or disconnecting power to a circuit to perform actions to fail access the PIN, encryption key, decryption key, and/or the like or to access an incorrect PIN, incorrect encryption key, incorrect decryption key, and/or the like, the processor of the payment instrument may optionally communicate with the POS to process the transaction (element 3275). With the incorrect PIN, encryption key, decryption key, and/or the like, the payment instrument may communicate with the POS and communicate with the payment service provider, informing one or both that the transaction may be fraudulent so the POS and/or the payment service provider may perform fraud prevention measures such as declining the transaction. In one embodiment, the payment service provide may maintain a counter to count the number of failed transactions as a result of an incorrect PIN, encryption code, decryption code, and/or the like, and may disable to payment instrument after a threshold number of failed transaction processing attempts. In some of these embodiments, the count is reset in response to a successful attempt to process a transaction. In some embodiments, the user may be able to reset the count by contacting an issuing bank or the payment service provider.

FIG. 3D illustrates a flowchart 3300 for a payment instrument with a lock. The payment instrument may include a user-configurable circuit that is user configurable (element 3310) and a user interaction mechanism to physically interact with a user to configure the user-configurable circuit (element 3315). The user interaction mechanism may comprise two or more slidable circuit connectors coupled with the user-configurable circuit. Each slidable connector may comprise a conductive element to electrically connect with the user-configurable circuit at one or more predefined locations. The slidable connectors may reside on the upper layer of the payment instrument and the user-configurable circuit may reside on one or more inner layers of the payment instrument with a portion of the processor. For instance, the lock logic circuitry may couple with the processor, memory, and/or other circuitry to provide the processor with a code, a PIN, environmental information, connect one or more circuits and/or disconnect one or circuits such as circuits that supply power to the processor, memory, NFC circuitry, the antenna, and/or the like.

Once the user sets the code via the slidable circuit connectors, in response to initiation of a POS transaction, the processor of the payment instrument may couple with the memory to identify a code from and/or via the user-configurable circuit configured by the user via the user interaction mechanism (element 3320). For instance, the user may receive a connector code such as a PIN for the payment instrument from a bank associated with the payment instrument. The bank may instruct the user to set the slidable connectors to show the connector code via placement of the connectors to process transactions. The connector code may be set via the slidable connectors to unlock the payment instrument for processing transactions. The user may change one or more of the slidable connectors' positions to change to user-configurable circuit, effectively changing the connector code on the face of the payment instrument to an incorrect code for unlocking the payment instrument.

In some embodiments, when slidable connectors are positioned in accordance with the correct connector code, the user-configurable circuit may provide a hidden code (which could be the same code or a different code from the connector code) to a processor of the payment instrument that is the correct code to unlock the payment instrument. In some embodiments, setting the slidable connectors to the correct connector code may set the hidden code provided to the processor as the PIN (or portion of the PIN), encryption code (or portion of the encryption code), and/or the like. In some embodiments, when the correct code is provided via the slidable connectors, the user-configurable circuit provides access, or electrically couples, the processor or the memory with a memory element that includes the PIN, portion of the encryption code, and/or the like. In some embodiments, when the correct code is provided via the slidable connectors, the user-configurable circuit provides access, or electrically couples, the processor or the memory with a memory element that includes one digit of the PIN, encryption code, and/or the like. In some embodiments, when the correct code is provided via the slidable connectors, the user-configurable circuit provides access, or electrically couples, the processor or the memory with a memory element that includes environmental information for the processor or an encrypted memory location that accesses the correct PIN, encryption code, and/or the like via a hash of environmental elements about (or proximate) the processor or an encrypted memory location, or within the payment instrument, to verify that the hardware coupled with the processor or an encrypted memory location has not changed since the manufacture of the payment instrument.

In some embodiments, provision of an incorrect code (also referred to as a lock code), the payment instrument may provide a lock code to the processor for processing a transaction. In some embodiments, provision of the lock code may allow the processor to communicate with a payment instrument, but communications may indicate a potentially fraudulent transaction.

After identifying the hidden code, the processor may use the hidden code to communicate with a POS terminal to process a transaction (element 3325). For instance, the POS may initiate a transaction and power circuitry in a payment instrument including the processor, memory, and the user configurable circuit. If the correct connector code is set with the user interaction mechanism prior to the application of power, the correct connector code is provided to the user configurable circuit, and the user configurable circuit may output a hidden code. The hidden code may comprise a PIN (or portion thereof), an encryption code (or portion thereof), a decryption code (or portion thereof), and/or the like. The processor may use the hidden code to generate a communication by, e.g., verifying the environment about the processor, decrypting an encryption key, appending the hidden code to a partial encryption code to create a complete or full encryption code, using the hidden code as the encryption code, and/or the like. If the connector code is not coded correctly via the slidable connectors, the processor may receive a lock code (an incorrect hidden code). The incorrect hidden code may cause the processor to fail to verify the environment about the processor, fail to decrypt an encryption key, append the incorrect hidden code to a partial encryption code to create an incorrect encryption code, use the incorrect hidden code as an incorrect encryption code, and/or the like. In some embodiments, the incorrect hidden code may cause the processor to fail to generate a communication, fail to create a communication that can be interpreted by the POS or a payment service server, fail to encrypt at least part of the communication with an encryption code that can be decrypted by the POS or payment service server, fail to decrypt an encryption key, and/or the like.

In some embodiments, the payment instrument and/or the payment service provider may detect the failed communication and increment a count in a failed transaction attempt counter. In such embodiments, the payment instrument and/or the payment service provider may block any further attempts to use the payment instrument by, e.g., checking the count in the counter prior to attempting to process a transaction. In some embodiments, the count may be reset in the failed transaction attempt counter.

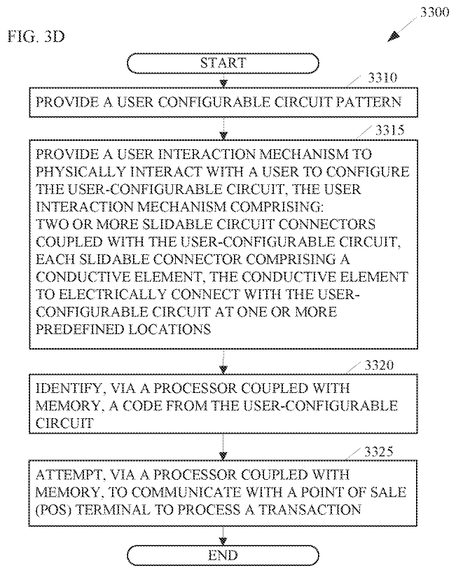

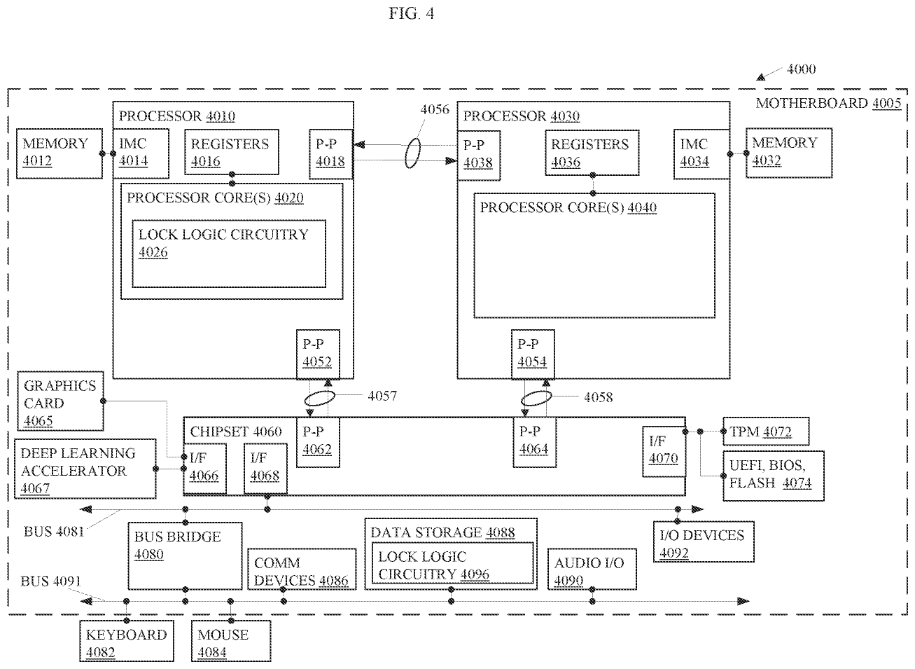

FIG. 4 illustrates an embodiment of a system 4000. The system 4000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 4000 may have a single processor with one core or more than one processor. Note that the term “processor” refers to a processor with a single core or a processor package with multiple processor cores.

As shown in FIG. 4, system 4000 comprises a motherboard 4005 for mounting platform components. The motherboard 4005 is a point-to-point interconnect platform that includes a first processor 4010 and a second processor 4030 coupled via a point-to-point interconnect 4056 such as an Ultra Path Interconnect (UPI). In other embodiments, the system 4000 may be of another bus architecture, such as a multi-drop bus. Furthermore, each of processors 4010 and 4030 may be processor packages with multiple processor cores including processor core(s) 4020 and 4040, respectively. While the system 4000 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 4010 and the chipset 4060. Some platforms may include additional components and some platforms may only include sockets to mount the processors and/or the chipset.

The first processor 4010 includes an integrated memory controller (IMC) 4014 and point-to-point (P-P) interconnects 4018 and 4052. Similarly, the second processor 4030 includes an IMC 4034 and P-P interconnects 4038 and 4054. The IMC's 4014 and 4034 couple the processors 4010 and 4030, respectively, to respective memories, a memory 4012 and a memory 4032. The memories 4012 and 4032 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 4012 and 4032 locally attach to the respective processors 4010 and 4030. In other embodiments, the main memory may couple with the processors via a bus and shared memory hub.

The processors 4010 and 4030 comprise caches coupled with each of the processor core(s) 4020 and 4040, respectively. In the present embodiment, the processor core(s) 4020 of the processor 4010 include a lock logic circuitry 4026 such as the lock logic circuitries 1015 and 1215 shown in FIGS. 1A and 1B, respectively. The lock logic circuitry 4026 may represent circuitry configured to implement the functionality to identify and support a lock code for a payment instrument within the processor core(s) 4020 or may represent a combination of the circuitry within a processor and a medium (such as the lock logic circuitry 1225 shown in FIG. 1B) to store all or part of the functionality of the lock logic circuitry 4026 in memory such as cache, the memory 4012, buffers, registers, and/or the like. In several embodiments, the functionality of the lock logic circuitry 4026 resides in whole or in part as code in a memory such as the lock logic circuitry 4096 in the data storage unit 4088 attached to the processor 4010 via a chipset 4060 such as the lock logic circuitry 1225 shown in FIG. 1B. The functionality of the lock logic circuitry 4026 may also reside in whole or in part in memory such as the memory 4012 and/or a cache of the processor. Furthermore, the functionality of the lock logic circuitry 4026 may also reside in whole or in part as circuitry within the processor 4010 and/or 4030 and may perform operations, e.g., within registers or buffers such as the registers 4016 and 4036 within the processors 4010 and 4030, respectively, or within an instruction pipeline of the processor 4010 and 4030, respectively.

In other embodiments, more than one of the processors 4010 and 4030 may comprise the functionality of the lock logic circuitry 4026 such as the processor 4030 and/or the processor within the deep learning accelerator 4067 coupled with the chipset 4060 via an interface (I/F) 4066. The I/F 4066 may be, for example, a Peripheral Component Interconnect-enhanced (PCI-e).

The first processor 4010 couples to a chipset 4060 via P-P interconnects 4052 and 4062 and the second processor 4030 couples to a chipset 4060 via P-P interconnects 4054 and 4064. Direct Media Interfaces (DMIs) 4057 and 4058 may couple the P-P interconnects 4052 and 4062 and the P-P interconnects 4054 and 4064, respectively. The DMI may be a high-speed interconnect that facilitates, e.g., eight Giga Transfers per second (GT/s) such as DMI 3.0. In other embodiments, the processors 4010 and 4030 may interconnect via a bus.

The chipset 4060 may comprise a controller hub such as a platform controller hub (PCH). The chipset 4060 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 4060 may comprise more than one controller hub such as a chipset with a memory controller hub, a graphics controller hub, and an input/output (I/O) controller hub.

In the present embodiment, the chipset 4060 couples with a trusted platform module (TPM) 4072 and the unified extensible firmware interface (UEFI), BIOS, Flash component 4074 via an interface (I/F) 4070. The TPM 4072 is a dedicated microcontroller designed to secure hardware by integrating cryptographic keys into devices. The UEFI, BIOS, Flash component 4074 may provide pre-boot code.

Furthermore, chipset 4060 includes an I/F 4066 to couple chipset 4060 with a high-performance graphics engine, graphics card 4065. In other embodiments, the system 4000 may include a flexible display interface (FDI) between the processors 4010 and 4030 and the chipset 4060. The FDI interconnects a graphics processor core in a processor with the chipset 4060.

Various I/O devices 4092 couple to the bus 4081, along with a bus bridge 4080 which couples the bus 4081 to a second bus 4091 and an I/F 4068 that connects the bus 4081 with the chipset 4060. In one embodiment, the second bus 4091 may be a low pin count (LPC) bus. Various devices may couple to the second bus 4091 including, for example, a keyboard 4082, a mouse 4084, communication devices 4086 and a data storage unit 4088 that may store code such as the malfunction detection logic circuitry 4096. Furthermore, an audio I/O 4090 may couple to second bus 4091. Many of the I/O devices 4092, communication devices 4086, and the data storage unit 4088 may reside on the motherboard 4005 while the keyboard 4082 and the mouse 4084 may be add-on peripherals. In other embodiments, some or all the I/O devices 4092, communication devices 4086, and the data storage unit 4088 are add-on peripherals and do not reside on the motherboard 4005.

FIG. 5 illustrates an example of a storage medium 5000 to store processor data structures. Storage medium 5000 may comprise an article of manufacture. In some examples, storage medium 5000 may include any non-transitory computer readable medium or machine readable medium, such as an optical, magnetic or semiconductor storage. Storage medium 5000 may store various types of computer executable instructions, such as instructions to implement logic flows and/or techniques described herein. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

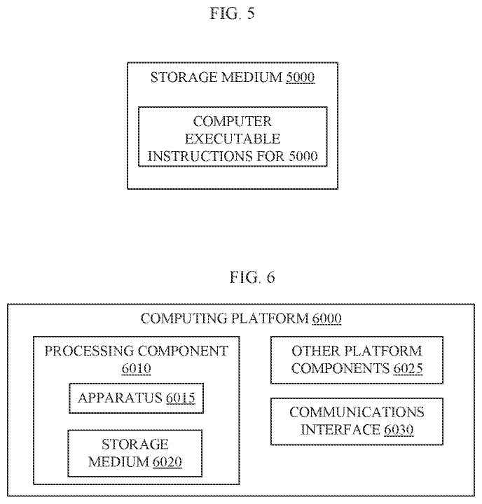

FIG. 6 illustrates an example computing platform 6000. In some examples, as shown in FIG. 6, computing platform 6000 may include a processing component 6010, other platform components or a communications interface 6030. According to some examples, computing platform 6000 may be implemented in a computing device such as a server in a system such as a data center or server farm that supports a manager or controller for managing configurable computing resources as mentioned above. Furthermore, the communications interface 6030 may comprise a wake-up radio (WUR) and may be capable of waking up a main radio of the computing platform 6000.

According to some examples, processing component 6010 may execute processing operations or logic for apparatus 6015 described herein such as the lock detection logic circuitry 1015, 1215, and 1225 illustrated in FIGS. 1A and 1B. Processing component 6010 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 6020, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 6025 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 6030 may include logic and/or features to support a communication interface. For these examples, communications interface 6030 may include one or more communication interfaces that operate according to various communication protocols or standards to communicate over direct or network communication links. Direct communications may occur via use of communication protocols or standards described in one or more industry standards (including progenies and variants) such as those associated with the PCI Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to infiniband Architecture Specification, Volume 1, Release 1.3, published in March 2015 (“the Infiniband Architecture specification”).

Computing platform 6000 may be part of a computing device that may be, for example, a server, a server array or server farm, a web server, a network server, an Internet server, a workstation, a mini-computer, a main frame computer, a supercomputer, a network appliance, a web appliance, a distributed computing system, multiprocessor systems, processor-based systems, or combination thereof. Accordingly, functions and/or specific configurations of computing platform 6000 described herein, may be included or omitted in various embodiments of computing platform 6000, as suitably desired.

The components and features of computing platform 6000 may be implemented using any combination of discrete circuitry, ASICs, logic gates and/or single chip architectures. Further, the features of computing platform 6000 may be implemented using microcontrollers, programmable logic arrays and/or microprocessors or any combination of the foregoing where suitably appropriate. It is noted that hardware, firmware and/or software elements may be collectively or individually referred to herein as “logic”.

It should be appreciated that the exemplary computing platform 6000 shown in the block diagram of FIG. 6 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores”, may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and also implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

What is claimed is:

1. A payment instrument comprising:
one or more user interaction mechanisms, the one or more user interaction mechanisms to physically interact with a user to change a user-configurable circuit, wherein the user interaction mechanism creates an unlock pattern with the user-configurable circuit to allow the payment instrument to authorize transactions and one or more lock patterns to prevent the payment instrument from authorizing transactions;
memory; and
logic circuitry comprising a processor to process transactions, the logic circuitry coupled with the memory to
receive power from a point of sale (POS) terminal to process a transaction;
apply the power to the user-configurable circuit, the user-configurable circuit coupled with one or more user interaction mechanisms; and
determine an output of the user-configurable circuit to attempt to process the transaction.

2. The payment instrument of claim 1, wherein the one or more user interaction mechanisms comprise moveable conductors to connect or disconnect circuits of the user-configurable circuit to create the unlock pattern.

3. The payment instrument of claim 1, wherein at least one of the one or more user interaction mechanisms connects a circuit of the user-configurable circuit with a conductor.

4. The payment instrument of claim 1, wherein at least one of the one or more user interaction mechanisms disconnects a circuit of the user-configurable circuit with a conductor.

5. The payment instrument of claim 1, wherein the unlock pattern provides power to the processor and the lock pattern prevents power from being applied to the processor.

6. The payment instrument of claim 1, wherein the unlock pattern provides a portion of an encryption code to an input of the processor to allow use of an encryption key.

7. The payment instrument of claim 1, wherein the unlock pattern provides an authentication code to an input of the processor to authenticate a known environment of the processor.

8. The payment instrument of claim 1, wherein the logic circuitry further comprises a counter to count a number of failed attempts to process the transaction and a comparator to determine if the number of failed attempts exceeds a threshold.

9. The payment instrument of claim 1, wherein positioning of the one or more user interaction mechanisms to create the unlock pattern is user definable, is defined at a time of manufacture of the payment instrument, or a combination thereof.

10. A non-transitory storage medium containing instructions, which when executed by a processor of a payment instrument, cause the processor to perform operations, the operations to:
in response to initiation of a point of sale (POS) transaction, apply power to a user-configurable circuit, the user-configurable circuit to output an unlock code in response to selection of an unlock pattern of circuit connections in the user-configurable circuit;
receive a code at an input of the processor of the payment instrument in response to power applied to a user-configurable circuit, the code to comprise the lock code or the unlock code; and
process the POS transaction via the code, wherein processing the POS transaction with the lock code generates a first communication that causes the POS transaction to fail and wherein processing the POS transaction with the unlock code generates a second communication that does not cause the POS transaction to fail.

11. The non-transitory storage medium of claim 10, further comprising counter logic to store and update a count of a number of failed attempts to process a transaction, wherein the count is reset in response to a successful attempt to process a transaction.

12. The non-transitory storage medium of claim 10, wherein the first communication causes the POS transaction to fail in response to encryption of the first communication with an incorrect encryption code.

13. The non-transitory storage medium of claim 12, wherein the code is added to the encryption code to create a complete encryption code.

14. The non-transitory storage medium of claim 10, further comprising operations to identify the code at a memory location associated with the user-configurable circuit.

15. The non-transitory storage medium of claim 10, the power applied to the user-configurable circuit to generate the code at a memory location.

16. The non-transitory storage medium of claim 10, the power applied to the user-configurable circuit to identify a memory location at which to access the code.

17. The non-transitory storage medium of claim 10, the power applied to the user-configurable circuit to identify a portion of the credit card number as the code.

18. The non-transitory storage medium of claim 10, wherein the first communication causes the POS transaction to fail in response to inclusion of incorrect information in the first communication.

19. The non-transitory storage medium of claim 10, wherein the first communication causes the POS transaction to fail in response to provision of an incorrect environmental input for the processor, the processor to verify that the environment about the processor has not changed prior to processing the transaction.

20. A payment instrument comprising:
a user configurable circuit;
a user interaction mechanism to physically interact with a user to configure the user-configurable circuit, the user interaction mechanism comprising:
two or more slidable circuit connectors coupled with the user-configurable circuit, each slidable connector comprising a conductive element, the conductive element to electrically connect with the user-configurable circuit at one or more predefined locations;
memory; and
a processor coupled with the memory and coupled with the user configurable circuit; the processor to:
identify a code from the user configurable circuit; and
attempt to communicate with a point of sale (POS) terminal to process a transaction.
